(19) United States
(12) Patent Application Publication
(10) Pub. No.: US 2014/0160551 A1
(43) Pub. Date: Jun. 12, 2014

(54) METHOD OF MODIFYING SURFACE OF CARBON BLACK AND DISPLAY DEVICE WITH THE CARBON BLACK

(71) Applicant: Electronics and Telecommunications Research Institute, Daejeon (KR)

(72) Inventors: Chul Am KIM, Daejeon (KR); Joo Yeon KIM, Daejeon (KR); Hojun RYU, Seoul (KR)

(73) Assignee: Electronics and Telecommunications Research Institute, Daejeon (KR)

(21) Appl. No.: 14/016,462

(22) Filed: Sep. 3, 2013

(30) Foreign Application Priority Data
Dec. 12, 2012 (KR) 10-2012-0144272

(51) Int. Cl. G02F 1/167; C09C 1/56

(52) U.S. Cl. CPC G02F 1/167; C09C 1/56
USPC 359/296; 554/161; 525/55

(57) ABSTRACT

Provided are methods of modifying a surface of carbon black and display devices with the carbon black. The display device may include an upper electrode, a lower electrode spaced apart from and facing the upper electrode, and a pigment between the upper and lower electrodes to include a plurality of micro-capsules. Each of the micro-capsules may include carbon black, whose surface may be modified to have hydrophobicity.

### CROSS-REFERENCE TO RELATED APPLICATIONS

This U.S. non-provisional patent application claims priority under 35 U.S.C. §119 to Korean Patent Application No. 10-2012-0144272, filed on Dec. 12, 2012, in the Korean Intellectual Property Office, the entire contents of which are hereby incorporated by reference.

### BACKGROUND OF THE INVENTION

Example embodiments of the inventive concept relate to a display device, and in particular, to a display device, in which carbon black is used as black particles.

Electronic paper displays may include an electrophoresis display, a liquid response particle display, an electrowetting mode display, or a microelectromechanical systems (MEMS) display. A micro-capsule electrophoresis display is one of electronic paper displays that are expected to be commercialized soon.

In the micro-capsule electrophoresis display, millions of black and white particles are injected in a capsule, whose size has an order of a diameter of a human hair. For example, the black and white particles are sandwiched between a transparent electrode and an operation electrode of the micro-capsule. So far, chromium oxide particles or iron oxide particles with modified surfaces are used for black-displaying particles, but they have technical disadvantages, such as high specific gravity, low bi-stability, a limitation in improving an operating voltage, low optical absorptivity, and low contrast property.

Further, the conventional carbon black particles may tend to be aggregated by van der Waals attraction exerted therebetween. That is, there may be a problem of self-aggregation in the conventional carbon black particles. This means that there is a difficulty in preserving carbon black particles dispersed in organic solvent or resin.

### SUMMARY

Example embodiments of the inventive concept provide a method of modifying surfaces of carbon black particles to be able to preserve dispersibility of the carbon black particles.

Other example embodiments of the inventive concept provide a display device provided with carbon black, whose surface is modified.

According to example embodiments of the inventive concepts, a display device may include an upper electrode, a lower electrode spaced apart from and facing the upper electrode, and a pigment between the upper and lower electrodes to include a plurality of micro-capsules. Each of the micro-capsules may include carbon black, whose surface may be modified to have hydrophobicity.

In example embodiments, a surface of carbon black is bonded to a carboxylic group including at least six carbon chains.

In example embodiments, the surface of the carbon black is bonded to oleic acid.

In example embodiments, the surface of the carbon black is bonded to a polymer.

In example embodiments, wherein the surface of the carbon black is bonded poly-poly(ethylene glycol)methacrylate (poly-PEGMA).

In example embodiments, a portion of the surface of the carbon black has hydrophilicity.

In example embodiments, wherein the surface of the carbon black is bonded hydroxyl group (—OH) or carboxylic group (—COOH).

According to example embodiments of the inventive concepts, a method of modifying a surface of carbon black may include hydrating a surface of each of dispersed carbon blacks, and performing a surface modifying process in such a way that the hydrated surface of the carbon black has hydrophobicity.

In example embodiments, the surface modifying process may include reacting hydroxyl group on the surface of the carbon black with carboxylic group of oleic acid to bond the oleic acid on the surface of the carbon black.

In example embodiments, the surface modifying process may include substituting hydroxyl group on the surface of the carbon black with chlorosilane to form a carbon black intermediate, and inducing an atom transfer radical polymerization reaction using the carbon black intermediate and solution containing PEGMA and a ligand donor material, thereby bonding poly-PEGMA on the surface of the carbon black.

In example embodiments, the ligand donor material may include bypyridine.

In example embodiments, the method may further include dispersing the aggregated carbon black using ultrasonic wave.

In example embodiments, the hydrating of the dispersed carbon blacks may include reacting the carbon blacks with acid solution, in which catalyst is mixed. The catalyst may include potassium permanganate, and the acid solution may include acetic acid.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a sectional view illustrating a display device according to example embodiments of the inventive concept.

FIG. 2A is a schematic diagram illustrating a method of modifying a surface of carbon black, according to example embodiments of the inventive concept.

FIG. 2B is a schematic diagram illustrating a method of modifying a surface of carbon black, according to other example embodiments of the inventive concept.

FIG. 3 is a graph showing a relation between a dispersion degree of aggregated carbon black and time taken to treat the aggregated carbon black with an ultrasonic disperser.

FIG. 4 is an infrared spectrum showing the presence of carbon black, whose surface is substituted with oleic acid.

FIG. 5 is a graph showing a zeta potential plotted over an amount of dispersion stabilizer in dielectric fluid dispersion solution, for carbon black with a surface substituted with oleic acid.

FIG. 6 is a graph showing optical characteristics of the device according to a mixture ratio between the white and black particles.

FIG. 7 is a graph showing a contrast ratio of white to black according to a mixing ratio between white and black particles.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments of the inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

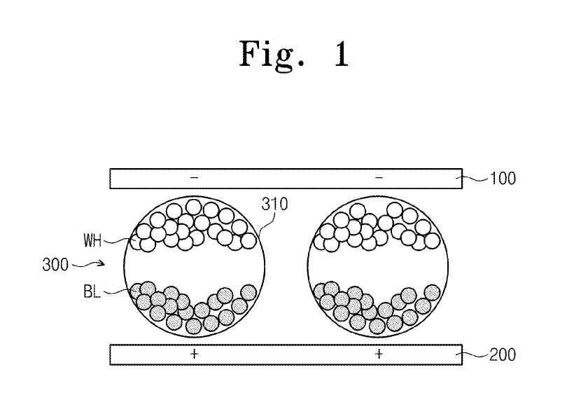

FIG. 1 is a sectional view illustrating a display device according to example embodiments of the inventive concept.

Referring to FIG. 1, a display device may include an upper electrode 100, a lower electrode 200, and a pigment 300 provided between the upper electrode 100 and the lower electrode 200.

The upper electrode 100 and the lower electrode 200 may be provided apart from each other to face each other. The upper electrode 100 and the lower electrode 200 may be transparent.

The pigment 300 may include a plurality of micro-capsules 310. Each of the micro-capsules 310 may include black particles BL and white particles WH. The black particles BL may be charged to have electric polarity opposite to that of the white particles WH. For example, the black particles BL may be negatively charged, while the white particles WH may be positively charged. In example embodiments, the black particles BL may include carbon black, and the white particles WH may include titanium oxide.

In the case where electric field is produced between the lower electrode 200 and the upper electrode 100, the white particles WH, which may be positively charged in the micro-capsules 310, may be moved toward top portions of the micro-capsules 310. In other words, the white particles WH may gather near a surface of each micro-capsule 310, and in this case, the display device may display ‘white’ color. In the meantime, the black particles BL may gather near opposite surface of each of the micro-capsules 310, and thus, ‘black’ color may not be displayed by the display device. By contrast, to display black letter or image, the electric field between the upper electrode 100 and the lower electrode 200 may be produced to have an opposite direction.

Carbon black particles, which may be used for the black particles BL, will be described in more detail below.

The carbon black may be chemically and thermally stable. The carbon black may exhibit low electric conductivity and high optical absorptivity. Accordingly, in the case where the carbon black is used for electronic ink, it is possible to realize a contrast ratio of at least 15:1 or more with respect to white color. However, conventional carbon black particles may tend to be aggregated by van der Waals attraction exerted therebetween.

According to example embodiments of the inventive concept, surfaces of the carbon black particles may be modified to have hydrophobicity, and thus, the carbon black particles may be dispersed in a form of single particle.

In example embodiments, to disperse the carbon black particles, surfaces of the carbon black particles may be modified with carboxylic acid including at least six carbon chains. For example, the carboxylic acid including at least six carbon chains may include oleic acid.

In other example embodiments, surfaces of the carbon black particles may be modified by grafting polymer thereon. For example, the polymer may include poly-(poly(ethylene glycol) methacrylate) (poly-PEGMA).

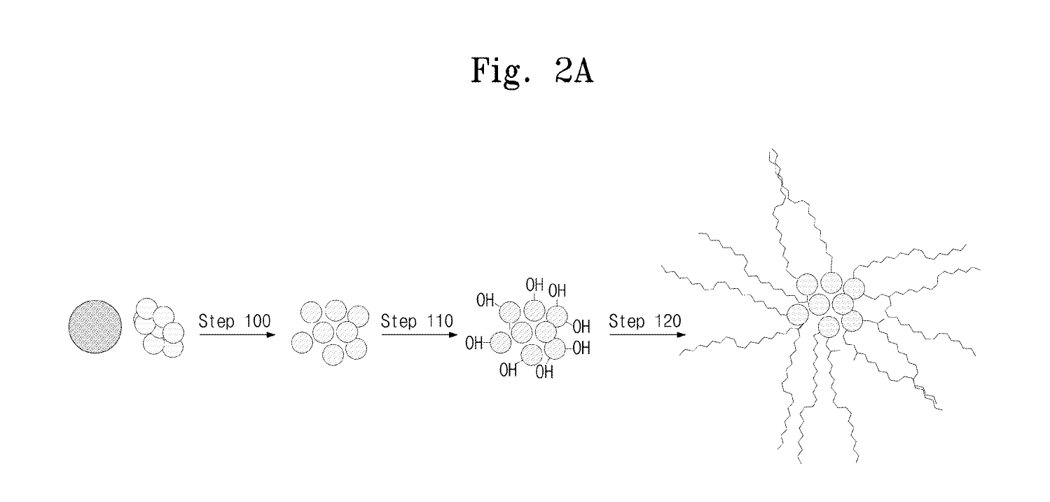

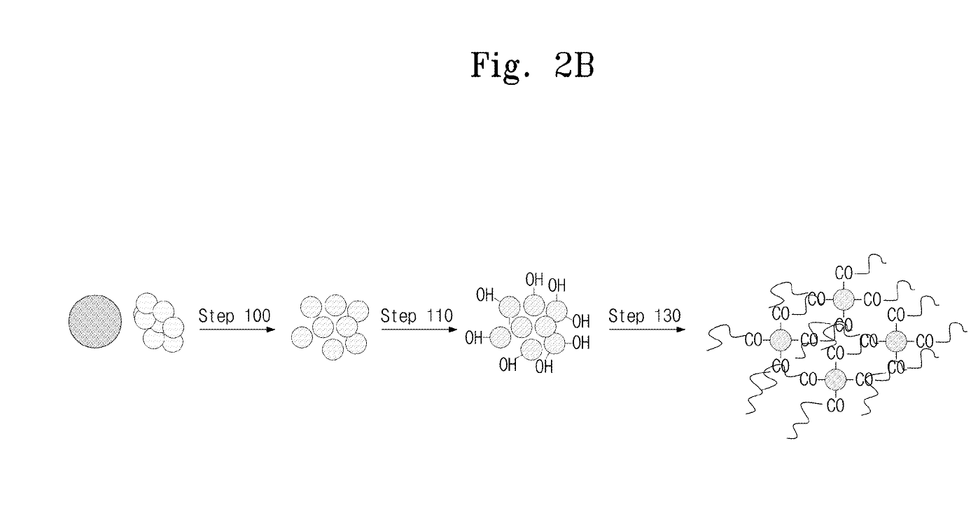

FIG. 2A is a schematic diagram illustrating a method of modifying a surface of carbon black, according to example embodiments of the inventive concept.

Aggregated carbon black particles may be dispersed using, for example, an ultrasonic disperser to form single carbon black particles that are separated from each other (in step 100). The aggregated carbon black particles may be treated, for about two hours, using the ultrasonic disperser. This will be described with reference to the experimental example.

The single carbon black particles may be dipped into acid solution to substitute a surface of the carbon black with hydroxyl group (—OH) (in step 110). According to example embodiments of the inventive concept, the acid solution may contain acetic acid. In example embodiments, the acid solution may further contain potassium permanganate (KMnO₄). The potassium permanganate may be used as phase-transfer catalyst. If the potassium permanganate is added into weak acid solution (e.g., acetic acid), it is possible to improve oxidation efficiency, relieve a reaction condition, and minimize loss of a carbon structure in the carbon black, compared with an oxidation process, in which relatively strong acid solution is used. According to other aspects of the inventive concept, the acid solution may further contain tetrabutylammonium bromide (TBABr). The TBABr may serve as a phase-transfer catalyst, for example, helping to extract the potassium permanganate of organic liquid phase, not of water phase.

Carbon black particles (CB—OH) with surfaces substituted with hydroxyl group may be cleaned and be re-distributed to remove un-reacted materials, and then, the carbon black may be dried to obtain particles. In example embodiments, the cleaning may be performed using a mixture of water and methanol. Here, the carbon black particles with surfaces substituted with the hydroxyl group may have a hydrophilic property, by virtue of the presence of the hydroxyl group.

The carbon black particles with surfaces substituted with the hydroxyl group may be mixed into solution containing carboxylic acid with at least six carbon chains. For example, a material containing the carboxylic acid with at least six carbon chains may include oleic acid. Hereinafter, for the sake of brevity, the carboxylic acid including at least six carbon chains will be referred to as ‘oleic acid’.

The hydroxyl group (—OH) of the carbon black surface and the carboxylic group (—COOH) of the oleic acid may participate in esterification. Accordingly, the oleic acid may be bonded to the surface of the carbon black particle (in step 120). The carbon black bonded with the oleic acid may have hydrophobicity, and thus, it is possible to prevent carbon blacks from being aggregated in a dielectric fluid.

The oleic acid bonded to the carbon black particle may include one end including carboxylic group (—COOH), other end including methyl group (—CH3), and an intermediate portion, which is made of hydrocarbons with hydrogen atoms bonded to a long carbon chain.

The carboxylic group has hydrophilicity and the hydrocarbons and methyl group have hydrophobicity. In addition, the longer the carbon chain, the higher hydrophobicity. In the case where the oleic acid is bonded to the surface of the carbon black as described above, the carbon black may have both hydrophobicity and weak hydrophilicity, i.e., amphipathy. Since the surface of the carbon black has hydrophilicity as described above, the carbon black may have charge stability.

FIG. 2B is a schematic diagram illustrating a method of modifying a surface of carbon black, according to other example embodiments of the inventive concept.

The carbon black particles with surfaces substituted with the hydroxyl group may be provided. Aggregated carbon black particles may be dispersed to form single carbon black particles that are separated from each other (in step 100), and a process of hydrating the surface of the dispersed carbon black (in step 110) may be performed in substantially the same manner as that described above, and thus, a detailed explanation of the hydrating process will be omitted.

The hydroxyl group surface of the carbon black (CB—OH) may be substituted with chlorosilane to form carbon black intermediate. For example, the carbon black with the surface containing the hydroxyl group may be mixed with solution containing trichloro(4-(chloromethyl)phenyl) silane), and thus, the hydroxyl group of the surface of the carbon black may be substituted with chlorosilane.

The carbon black intermediate, whose surface is substituted with chlorosilane, and solution containing a precursor and a ligand donor material may be participated in an atom transfer radical polymerization (in step 130). For example, the precursor may contain poly(ethylene glycol)methacrylate (PEGMA). The ligand donor material may contain bypyridine.

As a result, a polymer may be bonded to the surface of the carbon black intermediate through a grafting method. The polymer may contain poly-PEGMA. Hereinafter, for the sake of brevity, poly-PEGMA will be referred to as the polymer.

The carbon black, whose surface is grafted with poly-PEGMA, may have hydrophobicity. Since the carbon black has hydrophobicity, it is possible to prevent carbon blacks from being aggregated in a dielectric fluid.

In the meantime, the poly-PEGMA bonded to the surface of the carbon black particle may include one end including hydroxyl group (—OH) and a long carbon chain connected thereto. The hydroxyl group has hydrophilicity, and the long carbon chain has hydrophobicity. Further, the longer the carbon chain, the higher hydrophobicity. In the case where the poly-PEGMA is bonded to the surface of the carbon black as described above, the carbon black may have both hydrophobicity and weak hydrophilicity, i.e., amphipathy. Since the surface of the carbon black has hydrophilicity as described above, the carbon black may have charge stability.

### Experimental Example

### 1. Carbon Black Surface Modifying

Carbon Black, Whose Surface is Substituted with Hydroxyl Group

Aggregated carbon black was exposed to an ultrasonic disperser for two hours to form dispersed single carbon black particles. The dispersed carbon black particles was agitated and reacted with solution containing 100 mL tetrabu-tylammonium bromide (TBABr), 480 mL acetic acid, and KMnO₄, at room temperature for 24 hours. The carbon black particles were cleaned with a mixture of water and methanol, was centrifuged, and was re-dispersed to remove an un-reacted material. Next, a drying process was performed to obtain carbon black particles having a surface substituted with hydroxyl group.

Carbon Black, Whose Surface is Substituted with Oleic Acid

3 g carbon black with a surface substituted with hydroxyl group was dispersed with 200 mL hexane, and ten times diluted oleic acid was added therein, and the resulting solution was agitated at a temperature of 65° C. for 24 hours. Thereafter, the resulting material was cooled to room temperature, was cleaned five times with hexane, was centrifuged, and was re-dispersed to remove an un-reacted material. Next, a drying process was performed to obtain carbon black having a surface substituted with oleic acid.

Carbon Black, Whose Surface is Substituted with Poly-PEGMA

3 g carbon black with a surface substituted with hydroxyl group was dispersed in 100 mL toluene, and 0.91 mL triethylamine (TEA) was added therein, and the resulting solution was agitated for 30 minutes under nitrogen ambient at room temperature. After the agitation, 0.39 mL trichloro(4-(chloromethyl)phenyl)silane was injected therein using a syringe. After the injection of chlorosilane, the resulting material was agitated at room temperature for 24 hours to treat its surface with chlorosilane.

The un-reacted material was removed by performing the cleaning and centrifuging processes in order of chloroform, acetone, and ethanol, and then, the resulting material was cleaned with distilled water and was centrifuged to form carbon black intermediate, whose surface was treated with chlorosilane.

The 3 g carbon black intermediate was dispersed in 100 mL distilled water, and then, 2.4 mL PEGMA, 0.72 g CuCl, 0.195 g CuCl₂, and 0.225 g 2,2′-bypridine for forming ligand were added therein and were agitated and mixed for one hour in nitrogen ambient. After the mixing and agitating, the resulting material was agitated at temperature of 30° C. for 24 hours to obtain carbon black having a surface grafted with poly (PEGMA).

### 2. Dispersion of Aggregated Carbon Black Using an Ultrasonic Disperser

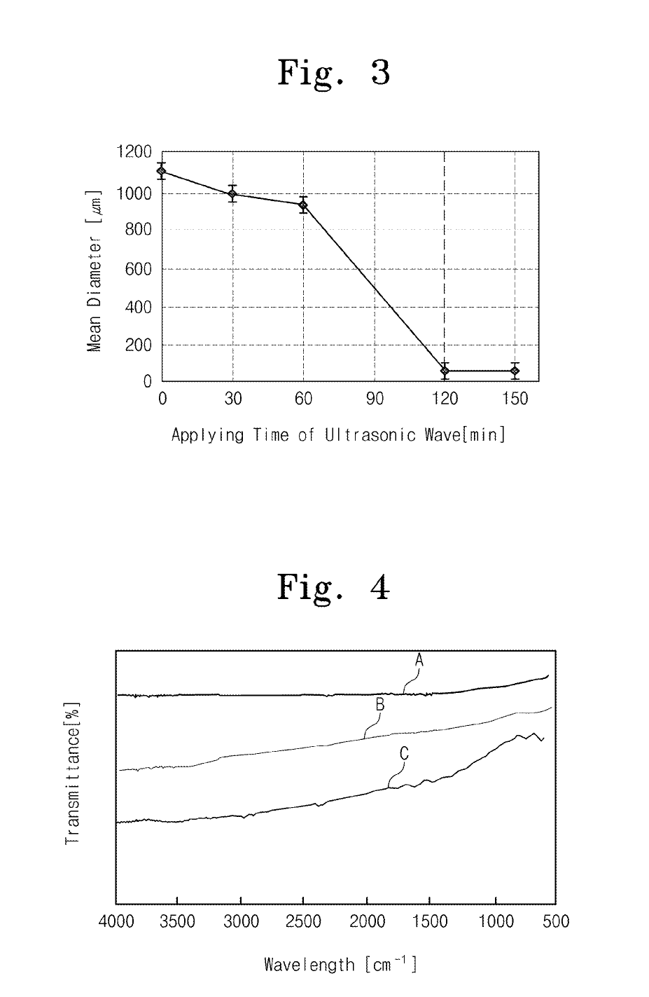

FIG. 3 is a graph showing a relation between a dispersion degree of aggregated carbon black and time taken to treat the aggregated carbon black with an ultrasonic disperser.

Referring to FIG. 3, a mean diameter of aggregated carbon black decreased with increasing time spent treating aggregated carbon black in the ultrasonic disperser. Especially, the mean diameter of the aggregated carbon black was abruptly decreased after about 60 min. Around about 120 min, the mean diameter of the aggregated carbon black was decreased to several tens of micrometers. The mean diameter of the aggregated carbon black was not decreased after 120 min. This means that the aggregated carbon blacks were dispersed to each other after 120 min

### 3. Confirming Carbon Black with a Surface Substituted with Oleic Acid

FIG. 4 is an infrared spectrum showing the presence of carbon black, whose surface is substituted with oleic acid.

In FIG. 4, the curve A is an infrared light spectrum of carbon black, which was formed by dispersing aggregated carbon black, without performing a surface modifying step. The curve B is an infrared light spectrum of carbon black, which was formed using the fabricating method according to the experimental example, and whose surface was substituted with hydroxyl group. The curve C is an infrared light spectrum of carbon black, which was formed using the fabricating method according to the experimental example, and whose surface was substituted with oleic acid.

The curve A has a peak at 2,942.1 cm⁻¹, which means that —CH group (or aliphatic CH) was contained therein.

The curve B has a peak at 3,600 cm⁻¹, which means that —OH group (or hydroxyl group) was contained therein. In other words, the carbon black fabricated by the experimental example had a surface with hydroxyl group.

The curve C has a peak at 1,710 cm⁻¹, which means that —C═O (carboxylic acid) was contained therein, and a peak at 1,310 cm⁻¹, which means that —C═C— (alkene group) was contained therein. In other words, the carbon black fabricated by the experimental example had a surface with oleic acid.

### 4. Zeta Potential Vs. Dispersion Stabilizer

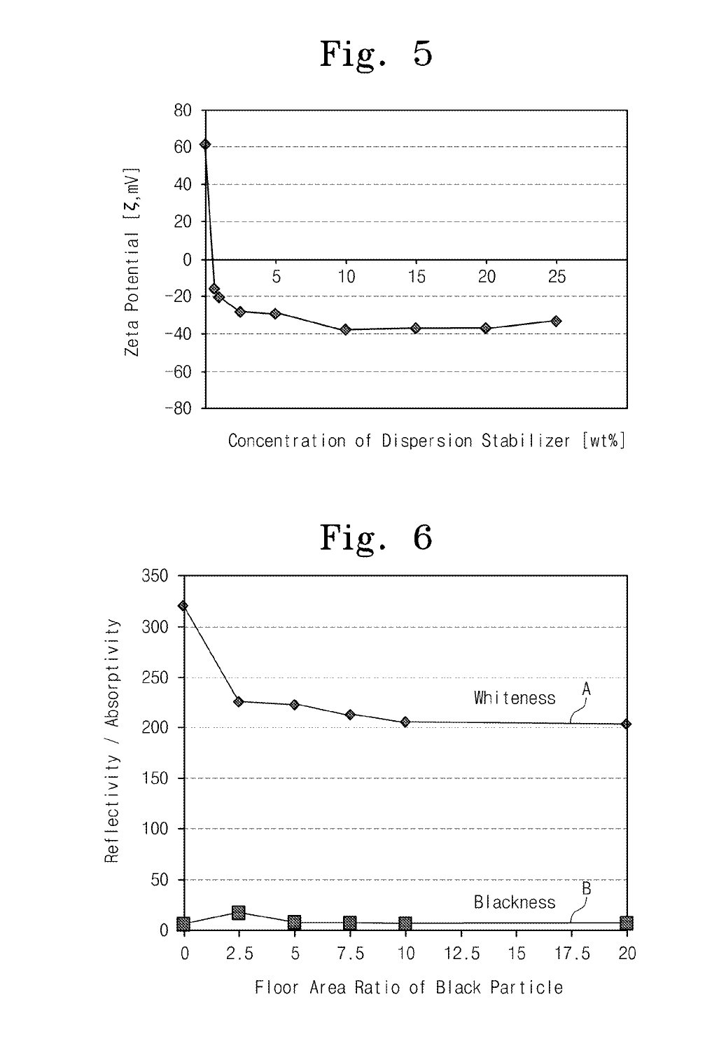

FIG. 5 is a graph showing a zeta potential plotted over an amount of dispersion stabilizer in dielectric fluid dispersion solution, for carbon black with a surface substituted with oleic acid.

Referring to FIG. 5, a zeta potential caused by a particle behavior was measured from carbon black with a surface substituted with oleic acid, which was fabricated by the experimental example, using Malvern Zeta-Sizer NS 9,000.

A sign of zeta potential was changed depending on a concentration (e.g., wt %) of the dispersion stabilizer. In the case that the concentration of the dispersion stabilizer was increased over about 10 wt %, the zeta potential was not changed substantially. This means that a critical concentration of the dispersion stabilizer was about 10 wt %.

### 5. Optical Characteristics of the Display Device

FIG. 6 is a graph showing optical characteristics of the device according to a mixture ratio between the white and black particles.

FIG. 6 was optical characteristics measured from the display device of FIG. 1. In detail, the display device included the upper electrode, the lower electrode, and the pigment. The space between the upper and lower electrodes was about 120 μm. The pigment contained black particles made of carbon black, whose surface was substituted with oleic acid, and white particles made of titanium oxide

Referring to FIG. 6, an optical characteristic of a display device was measured with changing a volume percent of a black pigment from 0 to 20, with respect to white. The curve A shows reflectivity of the display device, when −15V was applied to an upper electrode of the display device. The curve B shows absorptivity of the display device, when +15V was applied to the upper electrode of the display device.

The reflectivity of white decreases with increasing the volume percent of the black particle, and the absorptivity of black increases and then falls. In the case where the volume percent of black particles is 10, the reflectivity of white and the absorptivity of black were not changed substantially.

This shows that if carbon black with a surface substituted with oleic acid is used for the black particles, it is possible to prevent carbon blacks from being aggregated to each other, to improve a contrast ratio with respect to white pigment, and thereby to serve as black pigment.

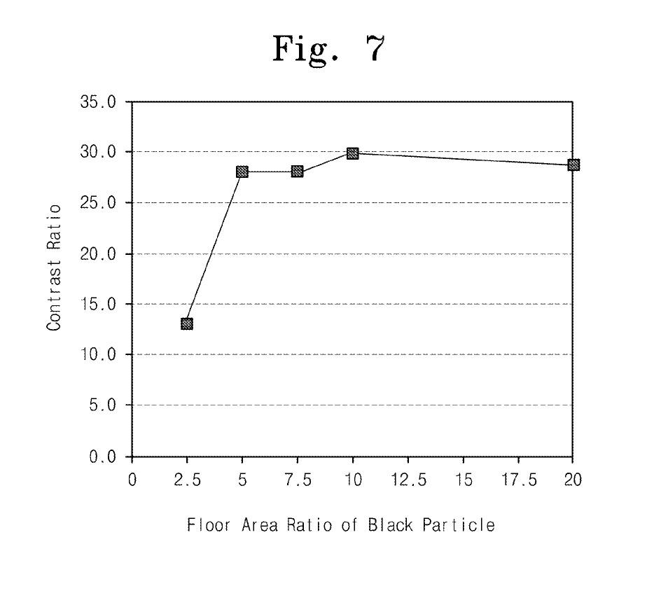

FIG. 7 is a graph showing a contrast ratio of white to black according to a mixing ratio between white and black particles.

FIG. 7 shows a contrast ratio of white to black was measured from the display device of FIG. 5. Referring to FIG. 7, when the black pigment or the carbon black with a surface substituted with oleic acid) had a volume percent of 2.5, a contrast ratio of white to black was about 15:1. When the black pigment had a volume percent of 6 or more, the contrast ratio of white to black was about 28:1.

This shows that if carbon black with a surface substituted with oleic acid is used for the black particles, it is possible to prevent carbon blacks from being aggregated to each other, to improve a contrast ratio with respect to white pigment, and thereby to serve as black pigment.

According to example embodiments of the inventive concept, since a surface of carbon black has hydrophobicity, it is possible to suppress carbon blacks from being aggregated to each other. Further, since at least a portion of the surface of the carbon black has hydrophilicity, the carbon black can have improved charge stability.

While example embodiments of the inventive concepts have been particularly shown and described, it will be understood by one of ordinary skill in the art that variations in form and detail may be made therein without departing from the spirit and scope of the attached claims.

What is claimed is:

1. A display device, comprising:
an upper electrode;
a lower electrode spaced apart from and facing the upper electrode; and
a pigment between the upper and lower electrodes to include a plurality of micro-capsules,
wherein each of the micro-capsules includes carbon black, whose surface is modified to have hydrophobicity.

2. The device of claim 1, wherein a surface of carbon black is bonded to a carboxylic group including at least six carbon chains

3. The device of claim 2, wherein the surface of the carbon black is bonded to oleic acid.

4. The device of claim 1, wherein the surface of the carbon black is bonded to a polymer.

5. The device of claim 4, wherein the surface of the carbon black is bonded poly-poly(ethylene glycol)methacrylate (poly-PEGMA).

6. The device of claim 1, wherein a portion of the surface of the carbon black has hydrophilicity.

7. The device of claim 6, wherein the surface of the carbon black is bonded hydroxyl group (—OH) or carboxylic group (—COOH).

8. A method of modifying a surface of carbon black, comprising:
hydrating a surface of each of dispersed carbon blacks; and
performing a surface modifying process in such a way that the hydrated surface of the carbon black has hydrophobicity.

9. The method of claim 8, wherein the surface modifying process includes reacting hydroxyl group on the surface of the carbon black with carboxylic group of oleic acid to bond the oleic acid on the surface of the carbon black.

10. The method of claim 8, wherein the surface modifying process includes;
substituting hydroxyl group on the surface of the carbon black with chlorosilane to form a carbon black intermediate; and
inducing an atom transfer radical polymerization reaction using the carbon black intermediate and solution containing PEGMA and a ligand donor material, thereby bonding poly-PEGMA on the surface of the carbon black.

11. The method of claim 10, wherein the ligand donor material includes bypyridine.

12. The method of claim 8, further comprising dispersing the aggregated carbon black using ultrasonic wave.

13. The method of claim 8, wherein the hydrating of the dispersed carbon blacks includes reacting the carbon blacks with acid solution, in which catalyst is mixed, and
wherein the catalyst includes potassium permanganate, and the acid solution includes acetic acid.
